(19) United States
(12) Patent Application Publication
(10) Pub. No.: US 2017/0039142 A1
(43) Pub. Date: Feb. 9, 2017

(54) Persistent Memory Manager

(71) Applicant: SanDisk Technologies LLC, Plano, TX (US)

(72) Inventors: Swaminathan Sundararaman, San Jose, CA (US); Santhosh Kumar Koundinya, Santa Clara, CA (US); Nisha Talagala, Livermore, CA (US); Jesus Ramos, San Jose, CA (US); Yuxuan Shui, Stony Brook, NY (US)

(21) Appl. No.: 15/209,680

(22) Filed: Jul. 13, 2016

Related U.S. Application Data
(60) Provisional application No. 62/200,573, filed on Aug. 3, 2015.

(51) Int. Cl. G06F 12/1009; G06F 3/06

(52) U.S. Cl. CPC G06F 12/1009; G06F 3/0604; G06F 3/064; G06F 3/0659; G06F 3/0665; G06F 3/0673; G06F 2212/152; G06F 2212/651; G06F 2212/657

(57) ABSTRACT

An address map has mapping data specifying a mapping between virtual addresses and physical addresses in persistent memory, consistent with both a memory mapped mode of access to data in a first data group and a block mode of access to the same data in the first data group. When using the block mode of access, a memory request by the user application is translated, in accordance with the address map, into a block mode persistent memory access command, for example using a file system and a block driver. When using the memory mapped mode of access, a memory request by the user application is translated, in accordance with the address map, into a direct persistent memory access command, bypassing the file system and block driver.

### RELATED APPLICATIONS

This application claims priority to U.S. Provisional Patent Application No. 62/200,573, filed Aug. 3, 2015, which is hereby incorporated by reference in its entirety.

### TECHNICAL FIELD

The disclosed embodiments relate generally to accessing data in persistent memory, for example a storage device having one or more non-volatile memory devices.

### BACKGROUND

In a computer system having a processor, persistent memory, an application executed in user space, and an operating system and various drivers executed in kernel space, when an application requests access to physical memory, the request typically specifies or is associated with one or more virtual memory addresses. In some systems configured to access persistent memory using block access, a file system maps the virtual addresses to block identifiers (sometimes called block IDs), which are then mapped to physical addresses in persistent memory by a block driver or the like. Typically, when using block access, entire blocks are accessed as a whole, and when a block is updated or overwritten, a new copy of the entire block is written to a new location in persistent memory and the old copy of the block in persistent memory is invalidated. In some systems configured to access persistent memory using memory mapped access, virtual addresses specified by an application are mapped to physical memory addresses using virtual address to physical address mapping mechanisms included in most modern processors and operating systems. Typically these two approaches, block access and memory mapped access, are mutually exclusive. As a result, an application typically can access any particular file, or database, or other data group (sometimes called a dataset) using block access, or memory mapped access, but not both.

### SUMMARY

Without limiting the scope of the appended claims, after considering this disclosure, and particularly after considering the section entitled “Detailed Description” one will understand how the aspects of various embodiments are implemented and used to access the same physical portions of persistent memory in multiple modes of access. The disclosed embodiments can access the same physical persistent memory region of an electronic device in a memory mapped mode of access and a block mode of access, and use a single address map to facilitate both modes of access.

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features.

FIG. 1 is conceptual diagram of software components in a computer system in which an application accesses data stored in persistent memory, in accordance with some embodiments.

FIG. 2 is a block diagram of an address map and a corresponding arrangement of data and metadata in persistent memory, in accordance with a first set of embodiments.

FIG. 3 is a block diagram of an address map and a corresponding arrangement of data and metadata in persistent memory, in accordance with a second set of embodiments.

FIG. 4 is a block diagram of a computer system in which an application accesses data stored in persistent memory, in accordance with some embodiments.

FIG. 5 illustrates a conceptual flowchart representation of a method of managing a persistent memory device, in accordance with some embodiments.

FIGS. 6A-6C illustrate a flowchart representation of a method of managing a persistent memory device, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The various implementations described herein include systems, methods and/or devices used to enable both block access and memory mapped access to the same data in persistent memory or to the same portions of persistent memory.

(A1) In some embodiments, a method for managing persistent memory in one or more persistent memory devices includes detecting a first memory request from a user application to access first specified data in a first data group (e.g., a specified file or database or other dataset) in persistent memory. The method includes, prior to detecting the first memory request, storing an address map having mapping data specifying a mapping between virtual addresses, used by the user application to access the first data group, and physical addresses in persistent memory at which data and metadata for the first data group is stored. The mapping is consistent with both a memory mapped mode of access to data in the first data group and a block mode of access to data in the first data group. Further, in accordance with the first memory request being a request to access the first specified data in the first data group using the memory mapped mode of access, the first memory request is translated into a persistent memory access command to access one or more locations in persistent memory that are determined in accordance with one or more virtual addresses specified by the first memory request and the stored mapping data. On the other hand, in accordance with the first memory request being a request to access the first specified data in the first data group using the block mode of access, the first memory request is translated into a persistent memory access command to access one or more blocks in persistent memory that are determined in accordance with one or more virtual addresses specified by the first memory request and the stored mapping data.

(A2) In some embodiments of the method of A1, the virtual addresses are in a virtual address space having first portions (e.g., portions sometimes herein called pages) of a first size (e.g., operating system page size), and the persistent memory has second portions (e.g., physical memory portions sometimes herein called blocks, or blocks of memory) of a second size different from the first size. The mapping data specifies a mapping between each first portion to an integer number of second portions, wherein the integer number is greater than one.

(A3) In some embodiments of the method of A1 or A2, the method further includes, in accordance with the first memory request being a request to access the first specified data in the first data group using the memory mapped mode of access, executing the persistent memory access command using a non-atomic method of execution. On the other hand, in accordance with the first memory request being a request to access the first specified data in the first data group using a block mode of access, the persistent memory access command is executed using an atomic method of execution.

(A4) In some embodiments the method of A1-A3 further includes, in accordance with the first memory request being a request to access the first specified data in the first data group using the block mode of access, executing the persistent memory access command via a file system and block driver. The method also includes, in accordance with the first memory request being a request to access the first specified data in the first data group using the memory mapped mode of access, executing the persistent memory access command using direct access to the persistent memory that bypasses the file system and block driver.

(A5) In some embodiments of the method of A1, a first sequence of memory requests is received, including the first memory request, and, prior to receiving the first sequence of memory requests, a block mode access command is received. The method further includes processing the first sequence of memory requests, including the first memory request, using the block mode of access and, after processing the first sequence of memory requests, receiving a memory mapped access command and a second sequence of memory requests, and processing the second sequence of memory requests using the memory mapped mode of access.

(A6) In some embodiments of the method in A5, in response to the memory mapped access command, the memory map is updated, as needed, such that the first portions of the virtual address space are each mapped to a contiguous set of the second portions in the physical address space. For example, the memory map is updated, as needed, such that respective pages in a set of pages in the virtual address space used by the application are each mapped to a contiguous set of blocks (i.e., at a contiguous set of physical locations) in persistent memory.

(A7) In some embodiments of the method of A1, the method further includes executing the persistent memory command to access the one or more locations in persistent memory by accessing a first location and a second location of the one or more locations in the persistent memory, the first location corresponding to a location within a first contiguous region of the persistent memory at which the metadata for the first data group is stored, and the second location corresponding to a location within a second contiguous region of the persistent memory at which the data for the first data group is stored.

(A8) In some embodiments of the method of A7 the first location and the second location correspond to an index value (i.e., the same index value) associated with the first data group. For example, the address map maps a virtual address specified by the user application (e.g., maps a block ID corresponding to the virtual address specified by a first memory request) to an index value, which corresponds to (or specifies) both a metadata entry in a contiguous metadata region of the persistent memory and a data block in a contiguous data region of the persistent memory.

(A9) In some embodiments of the method of A8, the index value is identified from the address map.

(A10) In some embodiments of the method of A7, accessing the first location is performed prior to accessing the second location, wherein accessing the first location comprises identifying, from the metadata stored at the first location, the second location at which the data for the first data group is stored. The method further includes accessing the second location, which comprises accessing the data for the first data group in accordance with the identified second location.

(A11) In some embodiments of the method of A10, the first location corresponds to a first index value, and the second location corresponds to a second index value distinct from the first index value.

(A12) In some embodiments of the method of A1, the persistent memory is organized into a sequence of extents, each extent having a respective first contiguous region for storing metadata and a respective second contiguous region for storing data.

(A13) In yet another aspect, a computing system includes non-volatile memory, one or more processors, and means for performing of the method of any one of A1 to A12 described above. For example, in some embodiments the means for performing of the method of any one of A1 to A12 comprises one or more software programs stored in memory of the computer system and configured for execution by the one or more processors.

(A14) In yet another aspect, a non-transitory computer-readable storage medium stores one or more programs (sometimes called software programs) configured for execution by one or more processors of a computing system, the one or more programs including instructions for causing the computing system to perform the method of any one of A1 to A12 described above.

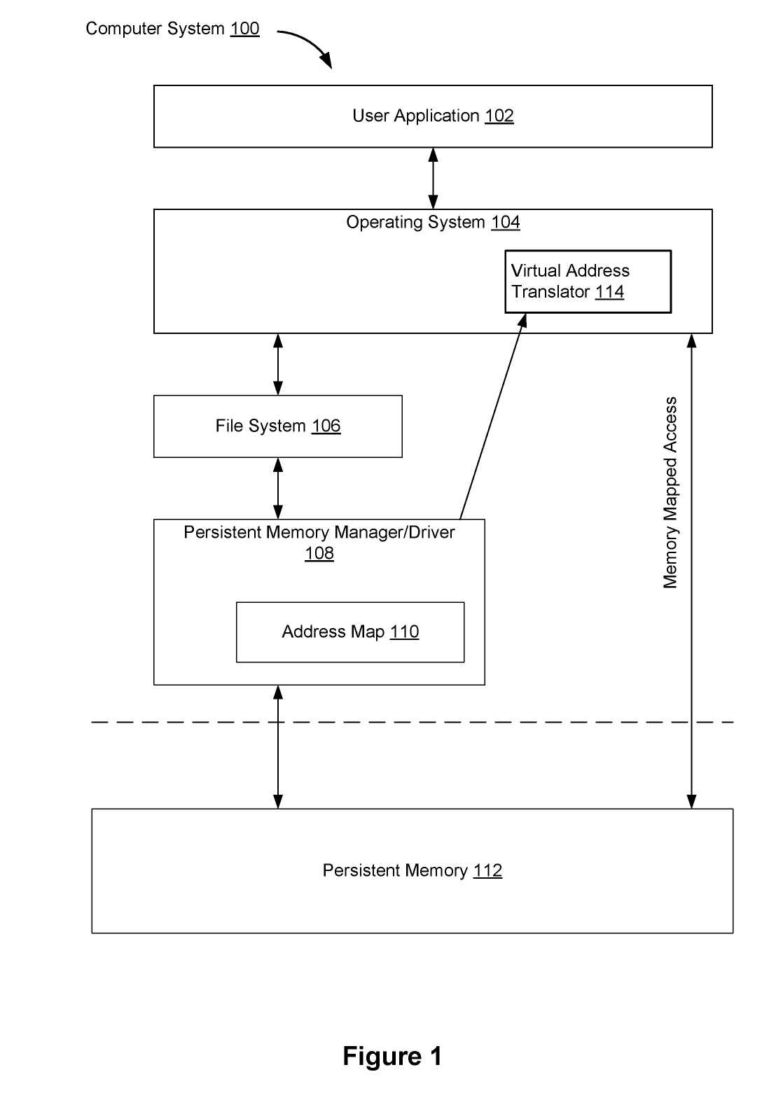

FIG. 1 is a block diagram illustrating software components of a computer system 100 (sometimes herein called a computing system), in accordance with some embodiments. FIG. 1 illustrates a user application 102 that sends memory access commands (e.g., reading from or writing to a file in non-volatile memory) to persistent memory 112. The user application 102 uses virtual addresses to specify which portions of a file, database or other dataset (sometimes herein called a data group) in persistent memory 112 to access, while physical addresses are used to actually access information in persistent memory 112.

In some embodiments, persistent memory 112 includes non-volatile RAM (NVRAM). Stated another way, in these embodiments, persistent memory 112 is implemented, at least in part, using NVRAM. However, persistent memory 112 may include multiple forms of non-volatile memory, such as two or more of battery-backed DRAM, flash memory, resistance RAM (RRAM), ferroelectric RAM, magnetoresistive RAM, phase-change RAM, or the like. The methods and embodiments of computer system 100 described herein are independent of the particular technology or technologies used to implement persistent memory 112.

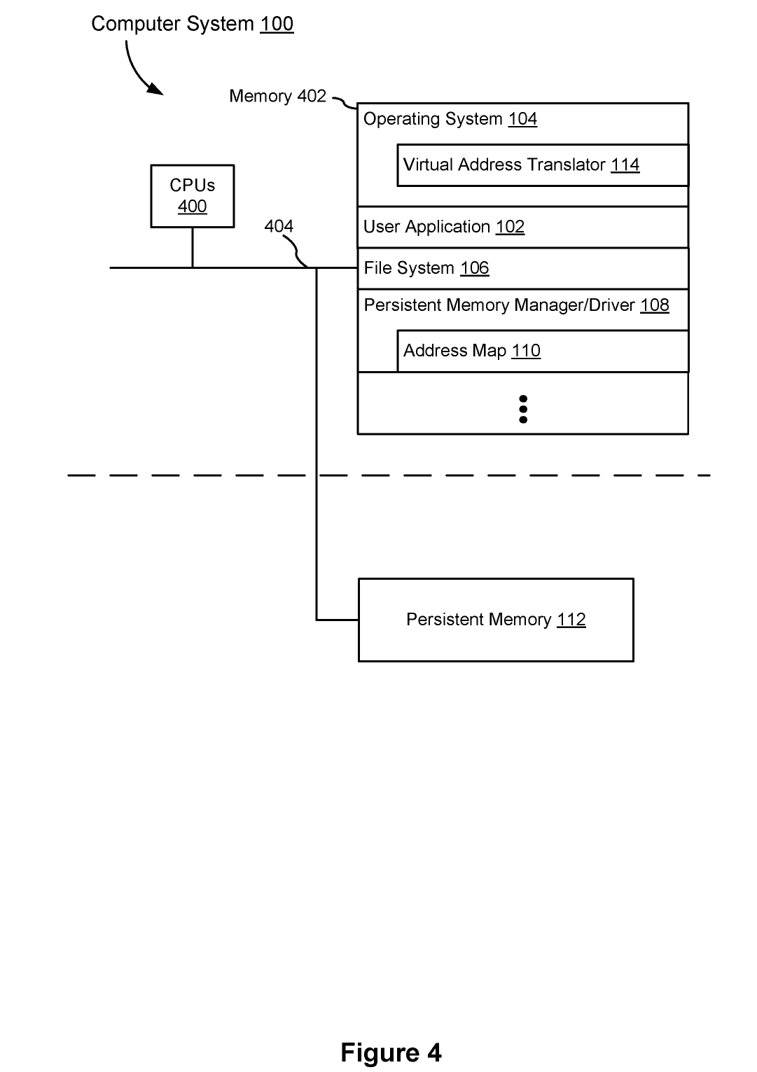

Similarly, the main memory of computer system 100 (e.g., memory 402, FIG. 4) is typically implemented using random access memory, such as DRAM. However, the methods and embodiments of computer system 100 described herein are independent of the particular technology or technologies used to implement main memory of computer system 100.

User application 102 is typically executed in user space, while operating system 104, file system 106 and persistent memory manager 108 are typically executed in kernel space. When a memory mapped mode of access is used, virtual addresses specified by memory access commands issued by user application 102 are translated by a virtual address translator 114 into physical addresses, which are then used to directly access memory. In some implementations, computer system 100 includes one or more processors (e.g., CPUs 400, FIG. 4) that include hardware mechanisms that support virtual address to physical address translation. But, the embodiments described herein are not dependent on any particular mechanisms used by computer system 100 to translation virtual addresses to physical addresses. Thus, virtual address translator 114 can be implemented in hardware or software or a combination.

Depending on the virtual addresses used by application 102, the memory that is directly accessed (in response to memory access commands issued by user application 102) is the main memory (e.g., memory 402, FIG. 4) of computer system 100 or persistent memory 112. For example, if user application 102 is accessing a portion of a file or database or other dataset (herein called a first data group) in persistent memory 112, the virtual address(es) specified by user application 102 are translated into physical addresses in persistent memory 112, and persistent memory is accessed directly, much as main memory is accessed directly by user application 102 when user application 102 issues memory access commands to access information stored in main memory. As a result, user application 102 can read and write both small and large portions of the first data group, in persistent memory 102, just as though the first data group were stored in main memory, without having to go through file system 106 and persistent memory manager 108 to mediate each command that accesses the first data group in persistent memory 112.

When a block mode of access is used, virtual addresses specified by memory access commands issued by user application 102 are conveyed by operating system 104 to file system 106, and those virtual addresses are translated by file system 106 into block identifiers and then physical addresses by file system 106 and/or persistent memory manager 108. The resulting physical addresses are physical addresses of memory blocks in persistent memory 112. Persistent memory manager 108 executes block mode persistent memory access commands, using those physical addresses, in order to read, write, invalidate and/or erase data in persistent memory 112, as specified by user program 102.

One of the features of the embodiments described herein is that user application 102 can access the same first data group using both the block mode of access and the memory mapped mode of access.

Although FIG. 1 shows computer system 100 in accordance with some embodiments, FIG. 1 is intended more as a functional description of the various features which may be present in computer system 100 than as a schematic of the embodiments described herein. In practice, and as recognized by those of ordinary skill in the art, the programs, modules, and data structures shown separately could be combined and some programs, modules, and data structures could be separated.

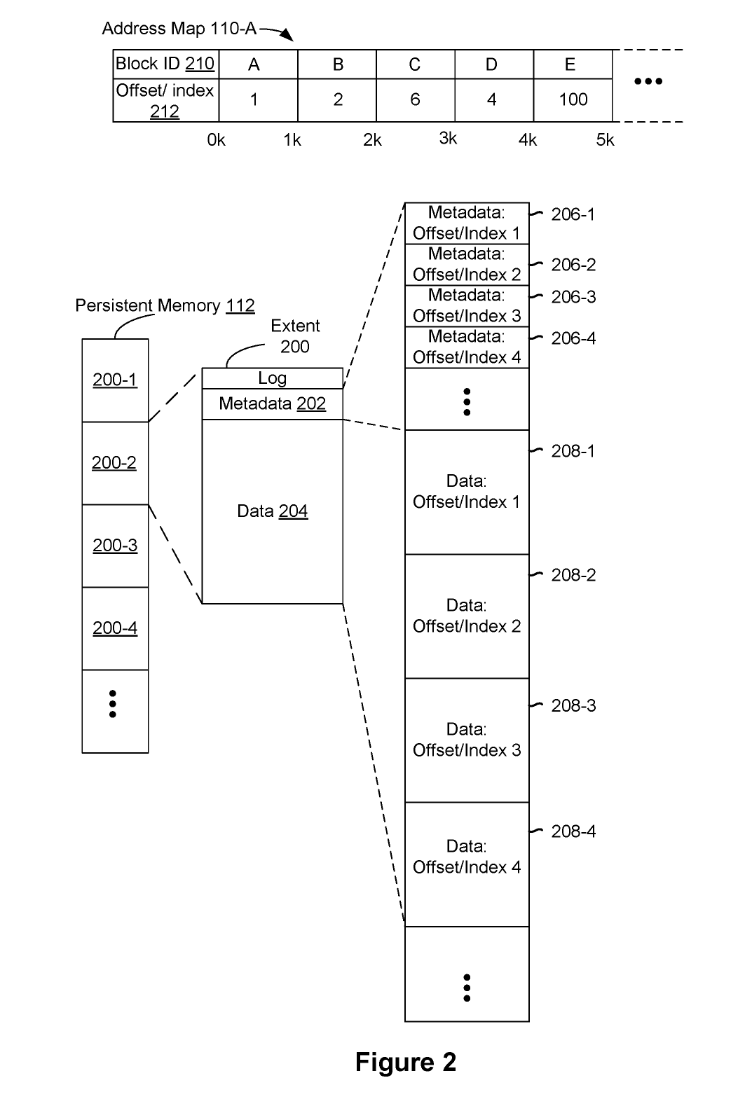

FIG. 2 illustrates persistent memory 112 and address map 110 (called address map 110-A in this example) in greater detail, in accordance with some embodiments. In some embodiments, persistent memory 112 includes a set or sequence of extents 200-1, 200-2, etc. In some embodiments an extent 200 includes a contiguous metadata region 202 and a contiguous data region 204. Contiguous metadata region 202 has a sequence of a metadata entries 206-1, 206-2, etc., where each metadata entry 206 has a first fixed size (e.g., 64 bytes, 128 bytes, or the like). Data region 204 has a sequence of a data entries (sometimes called data blocks) 208-1, 208-2, etc., where each data entry 208 has a second fixed size (e.g., 512 bytes, 1K byte, 4K bytes, 8K bytes, or the like) that is different from and typically much larger than (e.g., in some embodiments, at least four times as large as) the first fixed size. In the embodiments shown in FIG. 2, each data entry 208 has a corresponding metadata entry 206 that has the same offset or index as the data entry 208. Thus, metadata for the nth data entry 208-n is found in the nth metadata entry 206-n.

Address map 110-A maps block identifiers 210, often called block IDs, to offsets or indices 212 in persistent memory 112. For example, block identifier A is mapped to offset or index 1, which corresponds to metadata entry 206-1 and data entry 208-1. Similarly, block identifier B is mapped to offset or index 2, which corresponds to metadata entry 206-2 and data entry 208-2. However, as shown in FIG. 2, the offsets in address map 110-A need not progress in any particular order, as these values are dynamically determined as data is written to persistent memory 112. In some embodiments, address map 110-A is maintained and updated by persistent memory manager 108.

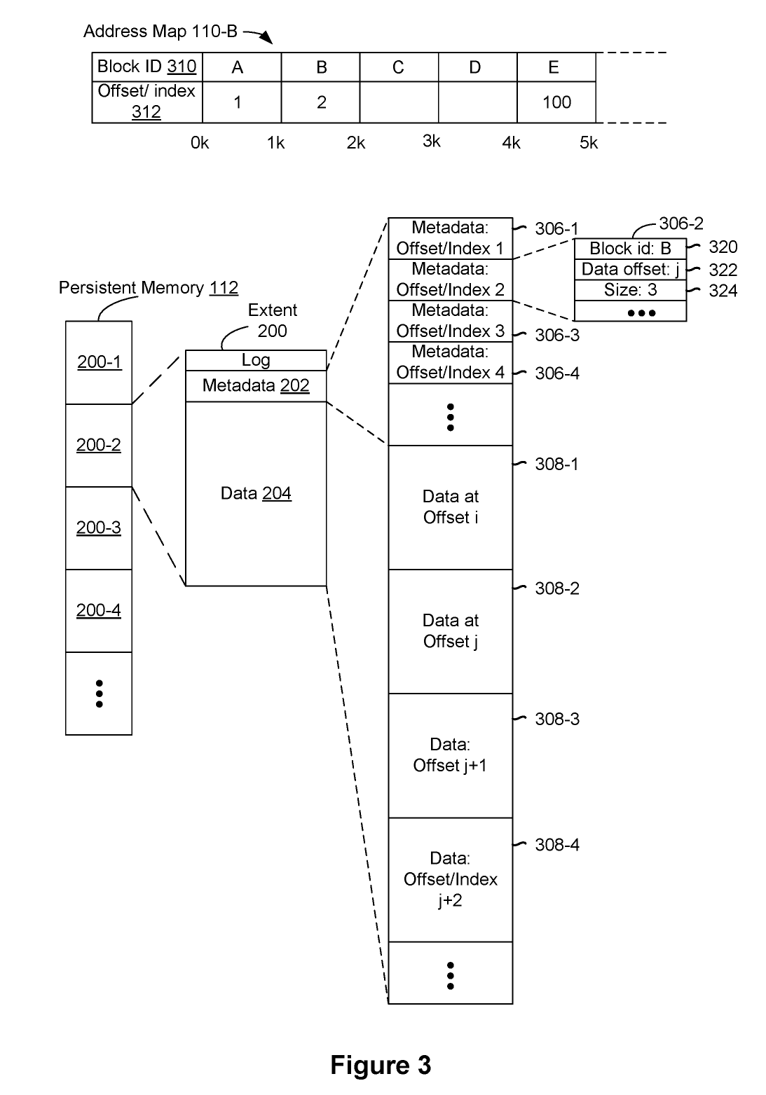

It is further noted that the block IDs 210 in address map 110-A (and in address map 110-B, FIG. 3) correspond to virtual addresses used by user application 102 to access a file, database, dataset or the like in persistent memory. In some embodiments, the block ID corresponding to a specified virtual address is obtained or computed by removing a predefined number of least significant bits from the virtual address, and then adding to the resulting value an offset corresponding to a starting block ID for the file, database, dataset or the like. In some embodiments, the predefined number of least significant bits is determined by the size of the data blocks 208 in persistent memory 112.

As noted above, the block ID corresponding to the specified virtual address is mapped, by address map 110-A, to an offset or index by address map 110-A. When the block mode of access is being used, the data block 208 identified by the offset or index is accessed as a whole. Furthermore, in some embodiments, when the memory mapped mode of access is being used, the aforementioned least significant physical bits of the virtual address are added to the starting address for the identified data block to obtain (e.g., compute) the physical address corresponding to the specified virtual address used by user application 102, and then that physical address in persistent memory is accessed directly.

FIG. 3 illustrates persistent memory 112 and address map 110 (address map 110-B in this example) in greater detail, in accordance with some embodiments in which persistent memory 112 is organized differently from what is shown in FIG. 2. In these embodiments, as in FIG. 2 persistent memory 112 includes a set or sequence of extents 200-1, 200-2, etc. An extent 200 includes a contiguous metadata region 202 and a contiguous data region 204.

In these embodiments, contiguous metadata region 202 has a sequence of a metadata entries 306-1, 306-2, etc., where each metadata entry 306 has a fixed size (e.g., 128 bytes, or the like). However, compared with the metadata entries 206 in FIG. 2, metadata entries 306, a respective metadata entry 306 includes a data offset 322 and a size 324, and optionally include a block identifier 320, where data offset 322 indicates a location in the data region 204 at which data corresponding to the respective metadata entry 306 is stored, and size 324 indicates how many contiguous data blocks 308, starting the data offset 322, correspond to the respective metadata entry 306. The optional block id 320 should match the block ID of the entry in address map 110-B that points to the respective metadata entry 306.

Data region 204 has a sequence of a data entries (sometimes called data blocks) 308-1, 308-2, etc., where each data entry or block 308 has the second fixed size (e.g., 512 bytes, 1K byte, 4K bytes, 8K bytes, or the like) that is different from and typically much larger than (e.g., in some embodiments, at least four times as large as) the fixed size of the metadata entries 306. In the embodiments shown in FIG. 3, each metadata entry 306 can corresponding to one or more data blocks 308. When a respective metadata entry 306 corresponds to two or more data blocks 308, those data blocks must be a contiguous set of data blocks 308 within data region 204. As a result, fewer metadata entries 306 are needed, on average, than in the embodiments shown in FIG. 2.

Address map 110-B maps block identifiers 310, also called block IDs, to offsets or indices 312 for metadata region 202 of persistent memory 112. For example, block identifier A is mapped to offset or index 1, which corresponds to metadata entry 306-1. Similarly, block identifier B is mapped to offset or index 2, which corresponds to metadata entry 306-2. However, as shown in FIG. 3, address map 110-B need not contain entries for many block IDs (for example address map 110-B in FIG. 3 does not have entries for block IDs C and D) for which data is stored because individual metadata entries can reference multiple data blocks 308. Further, in some embodiments, address map 110-B is stored as a sparse table, for example using a B-tree or other tree data structure. In some embodiments, address map 110-B is maintained and updated by persistent memory manager 108.

As explained above with reference to FIG. 2, in some embodiments, the block ID corresponding to a virtual address specified by a user application is obtained or computed by removing a predefined number of least significant bits from the virtual address, and then adding to the resulting value an offset corresponding to a starting block ID for the file, database, dataset or the like. In some embodiments, the predefined number of least significant bits is determined by the size of the data blocks 208 in persistent memory 112. The block ID corresponding to the specified virtual address is then mapped to a physical location in persistent memory 112. A procedure for doing that using address map 110-B is explained next.

Using the address map 110-B and persistent memory 112 organizational scheme shown in FIG. 3, data for a specified block ID is accessed by (A) finding the corresponding entry in address map 110-B to obtain an offset or index, (B) accessing the metadata entry 306 using the offset or index to obtain a data offset or index 322, and (C) accessing the data block corresponding to the specified block ID using the obtained data offset or index 322. For block IDs in a sequence of block IDs for which a single metadata entry 306 is stored, the corresponding address map entry is the entry in the address map for the closest lower block ID, and the corresponding data block is identified by adding a computed adjustment to the data offset in the metadata entry 306 for the sequence of block IDs.

For example, assuming that block IDs B, C and D in FIG. 3 are a sequence of block IDs for which a single metadata entry 306-2 is stored, a memory access command to access a virtual memory location corresponding to block ID D is executed as follows. First, the closest lower block ID in address map 110-B is determined. In this example, for block ID D, the closest lower block ID in address map 110-B is block ID B. Next, the metadata entry for block ID B is accessed to obtain the data offset in that metadata entry. In this example, metadata entry 306-2 is accessed to obtain data offset j. Next, a data offset adjustment is determined or computed. Since block ID D is offset by 2 (two) block IDs from the closest lower block ID in address map 110-B, block B, the data offset adjustment is 2. Finally, the data offset adjustment is added to the data offset obtained from metadata entry 306-2, resulting in a data offset of j+2, and the data block 308-4 corresponding to data offset j+2 is accessed.

More specifically, if the block mode of access is being used, the entire persistent memory data block 308-4 corresponding to data offset j+2 is accessed as a whole. But, if the memory mapped mode of access is being used, the least significant bits of the virtual address, which were removed when determining the corresponding block ID, are added to the starting address for the identified data block to obtain (e.g., compute) the physical address corresponding to the specified virtual address used by user application 102, and then that physical address in persistent memory is accessed directly.

It is noted that the sequence of operations described above is but one non-limiting example of how a memory access command specifying a virtual address is translated into a physical memory access command. Other sequences of operations may be used in various implementations.

FIG. 4 is a block diagram illustrating computer system 100, in accordance with some embodiments. It is noted that software components of system 100 are shown in FIG. 1, in accordance with some embodiments. Computer system 100 typically includes one or more processors 400 (also sometimes called CPUs or processing units or microprocessors or microcontrollers or physical processors) for executing modules, programs and/or instructions stored in memory 402 and thereby performing processing operations, memory 402, and one or more communication buses 404 for interconnecting these components. Communication buses 404 optionally include circuitry (sometimes called a chipset) that interconnects and controls communications between system components. Memory 402 (sometimes herein called main memory, to distinguish it from persistent memory 112) includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 402 optionally includes one or more storage devices remotely located from processor(s) 400. Memory 402, or alternately the non-volatile memory device(s) within memory 402, comprises a non-transitory computer readable storage medium. In some embodiments, memory 402, or the computer readable storage medium of memory 402 stores the following programs, modules, and data structures, or a subset thereof:
operating system 104, which includes procedures for handling various basic system services and for performing hardware dependent tasks;
user application 102;
file system 106; and
persistent memory manager 108 (sometimes called a persistent memory driver or block driver).

In some embodiments, operating system 104 includes a virtual address translator 114 that translates virtual addresses used by user application 102 to physical memory addresses, such as addresses in persistent memory 112. In some embodiments, virtual address translator 114 controls address translation hardware in processor(s) 400 that is configured for translating virtual addresses into physical addresses. As described in more detail below, virtual address translator 114 (and/or corresponding hardware in processor(s) 400) translates virtual addresses to physical memory addresses in persistent memory 112 in accordance with address mapping data in address map 110. Further, in some embodiments, persistent memory 112 is part of computer system 100, while in other embodiments, persistent memory 112 is in a system or subsystem, such as a solid-state storage device, that is separate from, but connected to, computer system 100.

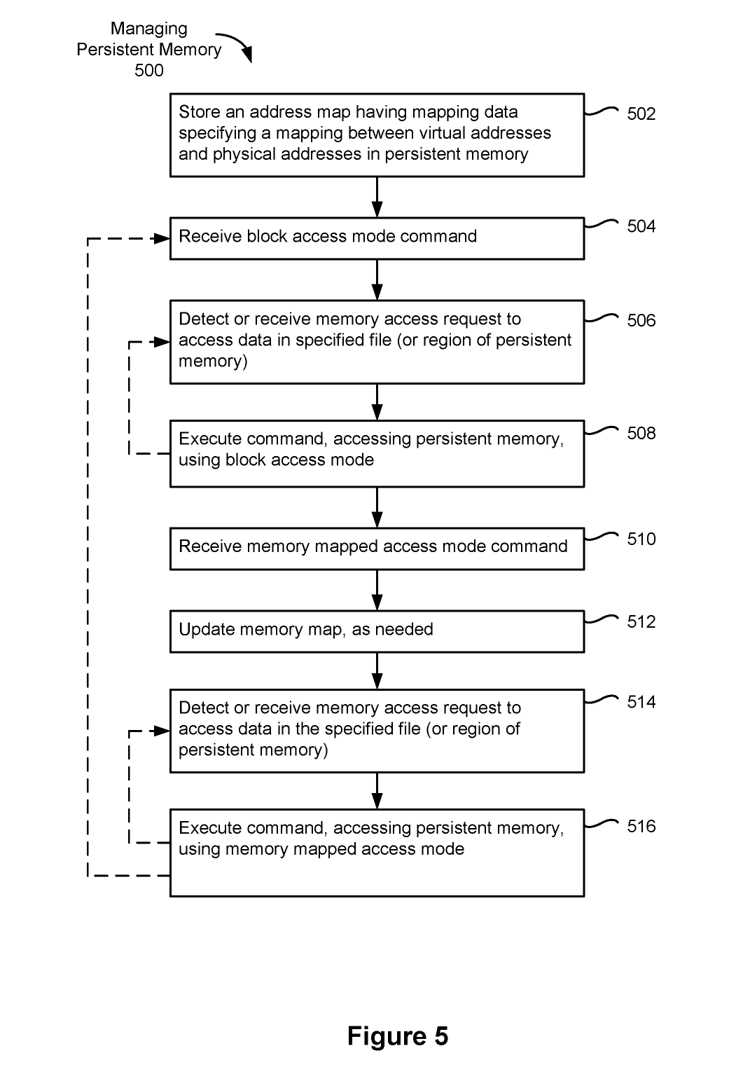

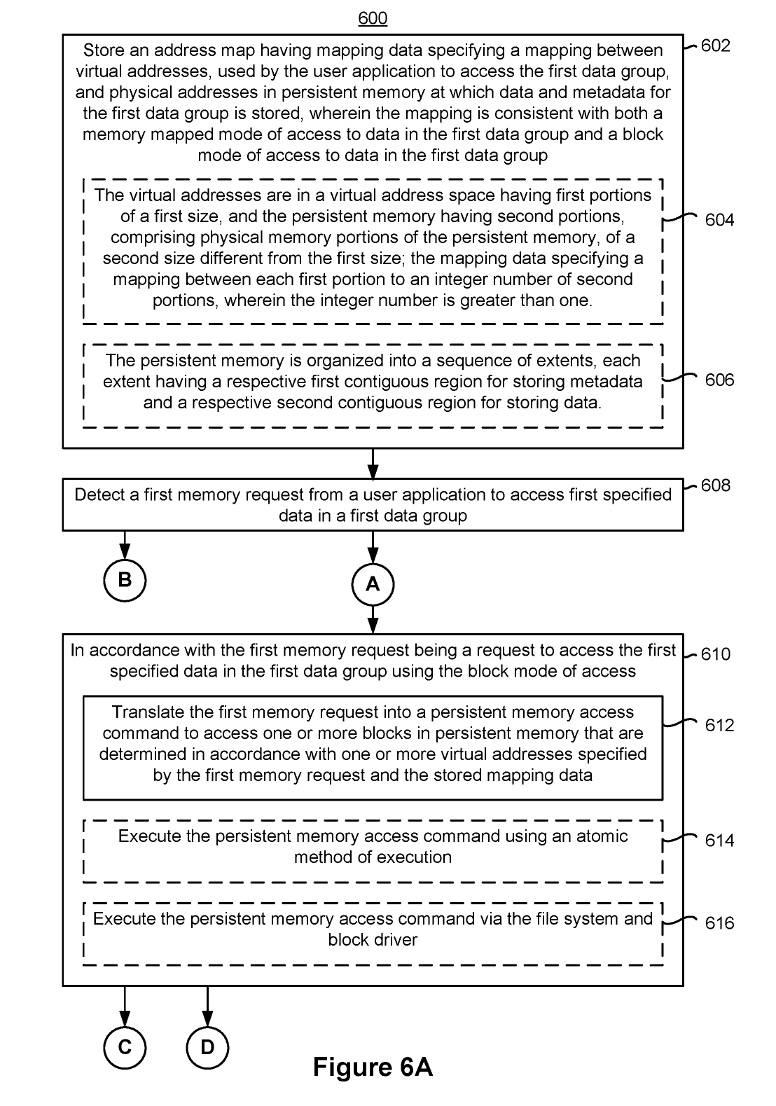

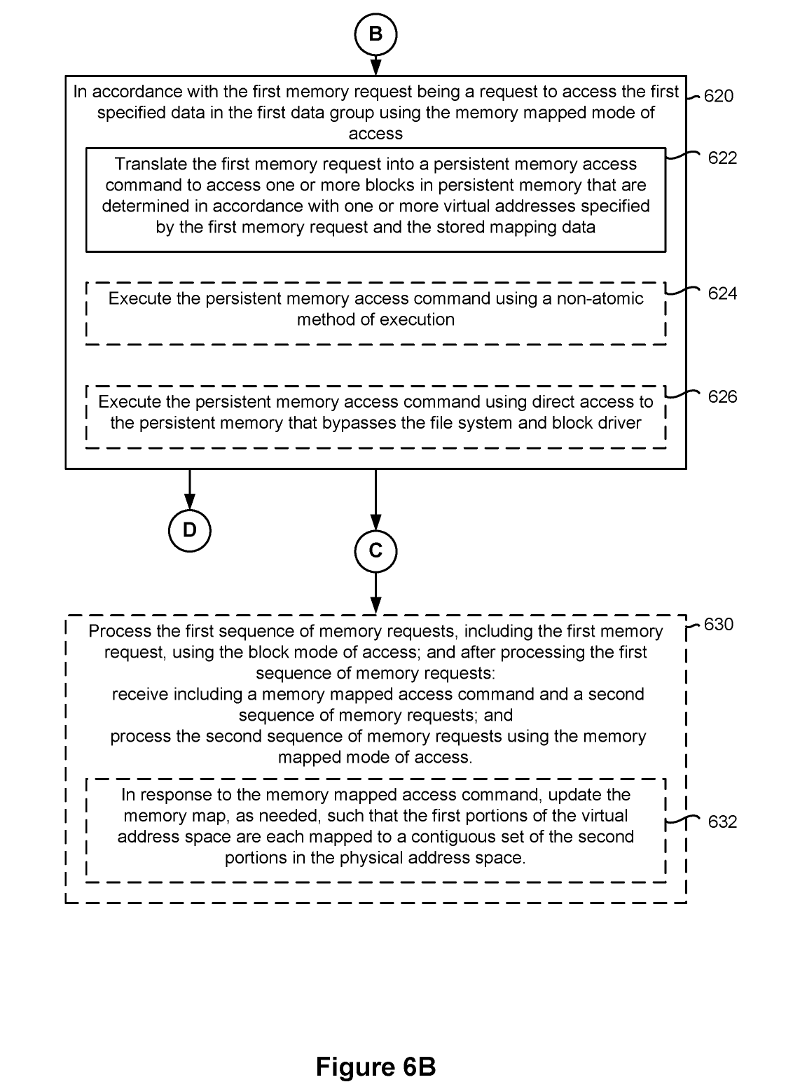

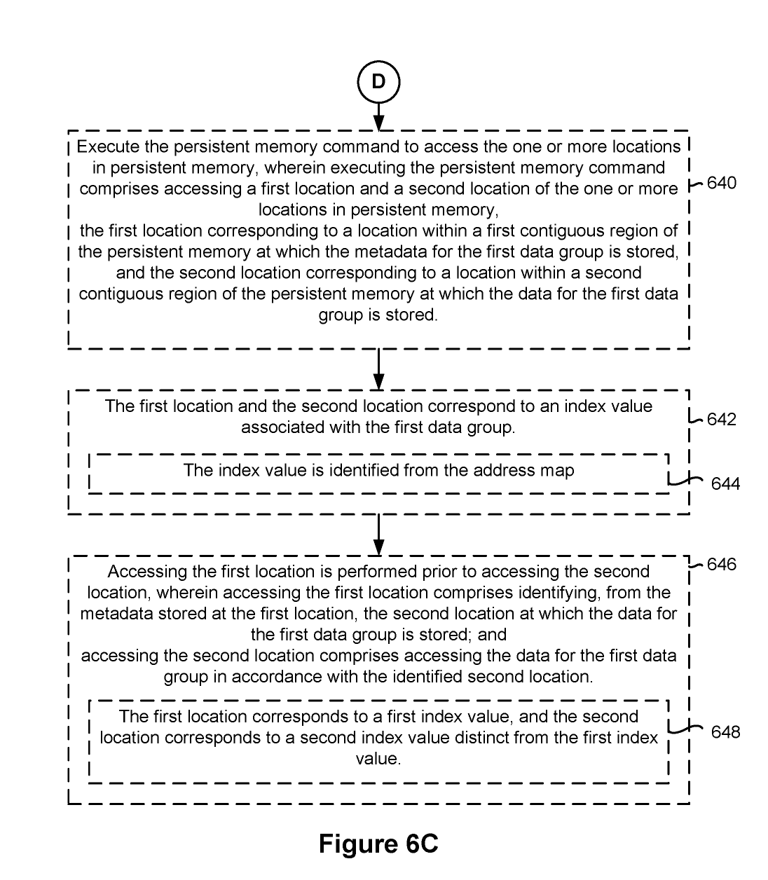

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 402 may store a subset of the modules and data structures identified above. Furthermore, memory 402 may store additional modules and data structures not described above. In some embodiments, the programs, modules, and data structures stored in memory 402, or the computer readable storage medium of memory 402, provide instructions for implementing respective operations in the methods described below with reference to FIGS. 5, and 6A-6C.

Although FIG. 4 shows computer system 100, FIG. 4 is intended more as a functional description of the various features which may be present in a non-volatile memory controller than as a structural schematic of the embodiments described herein. In practice, and as recognized by those of ordinary skill in the art, items shown separately could be combined and some items could be separated.

FIG. 5 illustrates a conceptual flowchart representation of a method for managing persistent memory 500 in a computer system such as computer system 100, in accordance with some embodiments. With reference to computer system 100 in FIGS. 1 and 4, in some embodiments, method 500 is performed by a computer system (e.g., computer system 100) or one or more components of the computer system (e.g., processors(s) 400, operating system 104, filed system 106, and/or persistent memory manager 108). In some embodiments, method 500 is governed by instructions that are stored in a non-transitory computer-readable storage medium and that are executed by one or more processors of a computing system, such as the one or more processing units (CPUs) 400 of computer system 100 (FIG. 4). For ease of explanation, the following describes method 500 as performed by computer system 100 of FIGS. 1 and 4. With reference to FIGS. 2 and 3, in some embodiments, persistent memory 112 is accessed using address map 110-A and the persistent memory 112 organizational scheme shown in FIG. 2, or address map 110-B and the persistent memory 112 organizational scheme shown in FIG. 3.

The method 500 begins, in some embodiments, by (502) storing an address map (e.g., in accordance with some embodiments, the address map 110-A of FIG. 2 or, in accordance with other embodiments, the address map 110-B in FIG. 3) that specifies a mapping of virtual addresses to physical addresses in persistent memory (e.g., persistent memory 112 of FIGS. 1-4). It is noted that while FIG. 5 shows operations 504-508 being executed first, and operations 510-516 being executed after operations 504-508, in various circumstances operations 510-516 can be executed before operations 504-508. In particular, an application can choose to first operate in either the block mode of access or the memory mode of access and can switch back and forth between the two modes of access, as needed.

Optionally, method 500 includes receiving (504) from an application (e.g., user application 102) a block access mode command, thereby notifying the operating system 104 that persistent memory 112 is to be accessed using a block mode of access when responding to commands from the application. In some other embodiments, block mode or access (sometimes called block access mode) may be the default mode, in which case a block access mode command need not be sent by the application unless switching from memory mapped access mode to block access mode.

Next, method 500 includes detecting or receiving (506) from the application one or more memory access requests to access data in a specified file or region of persistent memory. It is noted that the application may also be executing commands that access other memory media, such as main memory, but only commands to access persistent memory are addressed here.

Each such received command is executed (508). In block access mode, executing a command or memory access request to access data in the specified file or region of persistent memory includes mapping the virtual address or addresses specified by the memory access request to one or more physical addresses or physical address ranges in persistent memory. In some embodiments, a respective virtual address specified by a memory access request is mapped or translated into a physical address in persistent memory using any of the methodologies described above with respect to FIG. 2 and FIG. 3. In some embodiments, a file system (e.g. file system 106, FIGS. 1 and 4) maps the respective virtual address specified by the memory access request to a block identifier (sometimes called a block ID), which is then mapped to a physical address in persistent memory by a block driver (e.g., persistent memory manager 108, FIGS. 1 and 4). Once the virtual address has been mapped or translated into a physical address, the received command is executed using the block mode of access.

When executing memory access commands using the block mode of access, entire blocks (e.g., data blocks 208 or 308, FIG. 2 or 3) are accessed as a whole, and when a block is updated or overwritten, a new copy of the entire block is written to a new location in persistent memory and the old copy of the block in persistent memory is invalidated. As a result, write commands executed using the block mode of access cause the address map to be updated, regardless of whether the write command is writing data to a new location in a file, database or other dataset, or is overwriting existing data in the file, database or other dataset.

Furthermore, in some embodiments, memory access commands executed using the using a block mode of access are executed using an atomic method of execution. As a result, when the memory access command is a write command, failure of the command to execute results in none of the data specified by the command being stored in persistent memory, and successful execution of the command results in all of the data specified by the command being stored in the persistent memory.

More generally, as used herein, the term “atomic” refers to an operation that either succeeds as a whole, or fails as a whole. For example, an atomic execution of a write command specifying a block of write data will not be interrupted until either the block of write data is written to persistent memory, or the operation fails and the block is not written to persistent memory. Thus, the atomic execution of the write command in the given example will end in either a write completion of the specified write data, or a failure to write any blocks of data. In such an example, an atomic execution of the write command will not result in a partial completion, i.e., write completion of only a portion of the specified write data. With respect to read commands, atomic execution of a read command results in either all of the requested data being returned to the requesting application (i.e., in the case of success, execution of the command succeeds as a whole), or none of the requested data being returned to the requesting application (i.e., in the case of failure, execution of the command fails as a whole).

Method 500 further includes receiving (510) a memory mapped access mode command, which instructs the computer system to use the memory mapped mode of access, either generally when accessing data in persistent memory, or when accessing one or more specified data groups (e.g., one or more files, databases or other datasets). In some circumstances, after receiving the memory mapped mode of access command (510), method includes updating (512) the memory map as needed. In particular, in some embodiments, after receiving such a mode command, and before executing any memory access commands using the memory mapped mode of access, the address map is inspected to determine if each page in the portion of the virtual address space to which the mode command applies is mapped to a contiguous set of data blocks in persistent memory. If any pages in the portion of the virtual address space to which the mode command applies are not mapped to a contiguous set of data blocks in persistent memory, data is moved within persistent memory and the address map is correspondingly updated to the extent necessary so that each such page is mapped to a contiguous set of data blocks in persistent memory. This process is sometimes herein called “page aligning” virtual memory (or the portion of the virtual address space for a specified file, database or dataset) with physical memory.

As noted above, virtual address translator 114 (and/or corresponding hardware in processor(s) 400, FIG. 4) translates virtual addresses to physical memory addresses in persistent memory 112 in accordance with address mapping data in address map 110. In some embodiments, method 500 includes, in response to receiving (510) a memory mapped access mode command, generating or updating one or more page tables used by virtual address translator 114 using the address mapping data in address map 110, as updated by operation 512. Page tables are the data structures used by the virtual memory system (e.g., virtual address translator 114) of an operating system to map between virtual addresses and physical addresses.

Once the memory map is updated (512), as needed, method 500 continues with detecting or receiving (514) memory access requests (e.g., detecting or receiving memory access commands from the user application) to access data in a specified file, database or other data set in persistent memory, and executing (516) each such detected or received memory access command using the memory mapped mode of access. As described above, in the memory mapped mode of access, virtual addresses are translated into physical addresses by the computer system's processor(s) and operating system, for example using a virtual address translator. The resulting physical addresses are then used to directly access persistent memory (e.g., directly accessing the specified physical addresses in persistent memory). Furthermore, such direct access bypasses the file system and persistent memory manager.

In some embodiments, the operation 512 is performed by a background process, and execution of memory access commands is allowed to begin and continue, using the memory mapped mode of operation, until the application attempts to access a portion of the virtual address space that is not page aligned with data blocks in persistent memory. At that point, operation 512 is performed or completed, after which execution of memory access commands, using the memory mapped mode of operation, is allowed to resume.

In some circumstances, after performing operations 510-516, the application may switch back to the block mode of access for accessing the specified file, database or other data set in persistent memory, in which case the method continues by performing operations 504-508, as described above.

Additional details concerning the processing steps for method 500, as well as details concerning additional processing steps, are presented below with reference to FIGS. 6A-6C.

FIGS. 6A-6C illustrate a flowchart representation of a method 600 of managing persistent memory, in accordance with some embodiments. With reference to computer system 100 in FIGS. 1 and 4, in some embodiments, method 600 is performed by a computer system (e.g., computer system 100) or one or more components of the computer system (e.g., processors(s) 400, operating system 104, filed system 106, and/or persistent memory manager 108). In some embodiments, method 600 is governed by instructions that are stored in a non-transitory computer-readable storage medium and that are executed by one or more processors of a computing system, such as the one or more processing units (CPUs) 400 of computer system 100 (FIG. 4). For ease of explanation, the following describes method 600 as performed by computer system 100 of FIGS. 1 and 4. With reference to FIGS. 2 and 3, in some embodiments, persistent memory 112 is accessed using address map 110-A and the persistent memory 112 organizational scheme shown in FIG. 2, or address map 110-B and the persistent memory 112 organizational scheme shown in FIG. 3.

With reference to the computer system 100 of FIGS. 1 and 4, in some embodiments a computer system (e.g., the computer system 100) stores (602) an address map (e.g., address map 110) having mapping data specifying a mapping between virtual addresses, used by a user application to access a first data group (e.g., a file, database, dataset or specific region in persistent memory), and physical addresses in persistent memory (e.g., persistent memory 112) at which data and metadata (e.g., as discussed with regard to FIGS. 2 and 3) for the first data group is stored. The mapping is consistent with both a memory mapped mode of access to data in the first data group and a block mode of access to data in the first data group. In particular, the same mapping is used both for mapping virtual addresses to data blocks in persistent memory when using the block mode of access, and for mapping virtual addresses to individual physical addresses (e.g., physical addresses specifying particular bytes or words) in persistent memory when using the memory mapped mode of access. Examples of procedures for mapping virtual addresses to data blocks, and mapping virtual addresses to individual physical addresses, are provided above with reference to FIGS. 2 and 3.

In some embodiments the virtual addresses are (604) in a virtual address space (e.g., volatile memory) with first portions of a first size (e.g., portions sometimes herein called pages), and the persistent memory (e.g., persistent memory 112) having second portions (e.g., physical memory portions sometimes herein called data blocks, or blocks of memory) of a second size different from the first size. The mapping data specifies a mapping between each first portion to an integer number of second portions, where the integer number is greater than one (e.g., a page in the virtual address space is at least four times the size of a data block in persistent memory, and more generally the first portions are between 4 and 256 times the size of the second portions, in some embodiments).

In some embodiments, the persistent memory is organized (606) into a sequence of extents (e.g., see extents 200, as shown in FIGS. 2 and 3), each extent having a respective first contiguous region (e.g., metadata region 202, FIGS. 2 and 3) for metadata and a respective second contiguous region (e.g., data region 204, FIGS. 2 and 3) for data (sometimes called user data or application data).

Next, method includes detecting (608) or receiving a first memory request from the user application to access first specified data in a first data group (e.g., a file, database, data set or specified region of persistent memory) in persistent memory. In response to detecting or receiving the first memory request, and in accordance (610) with the first memory request being a request to access the first specified data in the first data group using a block mode of access, the first memory request is translated (612) into a persistent memory access command to access one or more blocks in persistent memory that are determined in accordance with one or more virtual addresses specified by the first memory request and the stored mapping data. As explained above with reference to FIGS. 2, 3 and 5, translating the first memory request into a persistent memory access command includes translating a virtual address specified by the first memory request into a physical address, in accordance with the stored address map.

In some embodiments, the method further includes, in accordance with the first memory request being a request to access the first specified data in the first data group using the block mode of access, executing (614) the persistent memory access command using an atomic method of execution. Atomic execution of the persistent memory access command is discussed above with reference to operation 508 of FIG. 5.

Further, in some embodiments the method includes, in accordance with the first memory request being a request to access the first specified data in the first data group using the block mode of access, executing (616) the persistent memory access command via a file system and block driver. For example, in some embodiments, a file system (e.g. file system 106, FIGS. 1 and 4) maps a virtual address specified by the first memory request to a block identifier (sometimes called a block ID), which is then mapped to a physical address in persistent memory by a block driver (e.g., persistent memory manager 108, FIGS. 1 and 4). Once the virtual address has been mapped or translated into a physical address, the persistent memory access command (which corresponds to the detected or received command) is executed using the block mode of access.

Optionally, operations 608-612 or 608-616 are repeated for additional memory requests from the user application, while the application or system continue to operate in the block mode of access.

In response to detecting or receiving the first memory request, and in accordance with the first memory request being (620) a request to access the first specified data in the first data group using the memory mapped mode of access, the first memory request is translated (622) into a persistent memory access command to access one or more locations in persistent memory that are determined in accordance with one or more virtual addresses specified by the first memory request and the stored mapping data. Further, in some embodiments, accordance with the first memory request being a request to access the first specified data in the first data group using the memory mapped mode of access, the persistent memory access command is executed (624) using a non-atomic method of execution. Thus, when using the memory mapped mode of access, persistent memory access commands are executed without a guarantee that the execution will either succeed as a whole, or fail as a whole. As a result, there is a small possibility of the first data group being left in an inconsistent state as a result of a failed execution of a persistent memory access command that is executed using the memory mapped mode of access.

The method also includes, in accordance with the first memory request being a request to access the first specified data in the first data group using the memory mapped mode of access, executing (626) the persistent memory access command using direct access to the persistent memory that bypasses the file system and block driver.

In some embodiments, method 600 includes receiving (630) a first sequence of memory requests, including the first memory request, and, prior to receiving the first sequence of memory requests, receiving a block mode access command. The method further includes (630) processing the first sequence of memory requests, including the first memory request, using the block mode of access and, after processing the first sequence of memory requests, receiving a memory mapped access command and a second sequence of memory requests, and processing the second sequence of memory requests using the memory mapped mode of access. In some embodiments, in response to the memory mapped access command, the memory map is updated (632), as needed, such that the first portions of the virtual address space are each mapped to a contiguous set of the second portions in the physical address space. For example, the memory map is updated, as needed, such that respective pages in a set of pages in the virtual address space used by the application are each mapped to a contiguous set of blocks (i.e., at a contiguous set of physical locations) in persistent memory. Additional aspects of updating the address map in response to the memory mapped access command are discussed above with respect to operation 512 of method 500.

In some embodiments, method 600 further includes executing (640) the persistent memory command to access the one or more locations in persistent memory by accessing a first location and a second location of the one or more locations in the persistent memory. The first location corresponds to a location within a first contiguous region of the persistent memory at which the metadata for the first data group is stored, and the second location corresponds to a location within a second contiguous region of the persistent memory at which the data for the first data group is stored.

In some embodiments, the first location and the second location correspond 642) to an index value (i.e., the same index value) associated with the first data group. Furthermore, in some embodiments, the index value is identified (644) from the address map. For example, as shown in FIG. 2, an address map 110-A maps a block ID, corresponding to the virtual address specified by first memory request the user application, to an index value, which corresponds to (or specifies) both a metadata entry 206 in a contiguous metadata region 202 of the persistent memory and a data block 208 in a contiguous data region 204 of the persistent memory (e.g., persistent memory 112). The correspondence of block IDs to virtual addresses is explained above with reference to FIG. 2.

In some embodiments, such as embodiments using an address map 110-B and persistent memory organization scheme as shown in FIG. 3, accessing the first location is performed (646) prior to accessing the second location, where accessing the first location includes identifying, from the metadata stored at the first location, the second location at which the data for the first data group is stored. In these embodiments, the method further includes accessing the second location, including accessing the data for the first data group in accordance with the identified second location. In some of these embodiments, the first location corresponds (648) to a first index value, and the second location corresponds to a second index value distinct from the first index value. Further explanation of such embodiments is found above with respect to FIG. 3.

It will be understood that, although the terms “first,” “second,” etc. may be used herein to describe various elements, these elements should not be limited by these terms. These terms are only used to distinguish one element from another. For example, a first transistor could be termed a second transistor, and, similarly, a second transistor could be termed a first transistor, without changing the meaning of the description, so long as all occurrences of the “first transistor” are renamed consistently and all occurrences of the “second transistor” are renamed consistently. The first transistor and the second transistor are both transistors, but they are not the same transistor.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method for managing persistent memory in one or more persistent memory devices comprising a plurality of physical memory portions, the method comprising:
detecting a first memory request from a user application to access first specified data in a first data group;
prior to detecting the first memory request,
storing an address map having mapping data specifying a mapping between virtual addresses, used by the user application to access the first data group, and physical addresses in persistent memory at which data and metadata for the first data group is stored, wherein the mapping is consistent with both a memory mapped mode of access to data in the first data group and a block mode of access to the data in the first data group;
in accordance with the first memory request being a request to access the first specified data in the first data group using the memory mapped mode of access,
translating the first memory request into a persistent memory access command to access one or more locations in persistent memory that are determined in accordance with one or more virtual addresses specified by the first memory request and the stored mapping data; and
in accordance with the first memory request being a request to access the first specified data in the first data group using the block mode of access,
translating the first memory request into a persistent memory access command to access one or more blocks in persistent memory that are determined in accordance with one or more virtual addresses specified by the first memory request and the stored mapping data.

2. The method of claim 1, wherein
the virtual addresses are in a virtual address space having first portions of a first size, and the persistent memory having second portions, comprising said physical memory portions of a second size different from the first size; the mapping data specifying a mapping between each first portion to an integer number of second portions, wherein the integer number is greater than one.

3. The method of claim 1, further comprising:
in accordance with the first memory request being a request to access the first specified data in the first data group using the memory mapped mode of access:
executing the persistent memory access command using a non-atomic method of execution; and
in accordance with the first memory request being a request to access the first specified data in the first data group using a block mode of access,
executing the persistent memory access command using an atomic method of execution.

4. The method of claim 1, further comprising:
in accordance with the first memory request being a request to access the first specified data in the first data group using a block mode of access,
executing the persistent memory access command via a file system and block driver; and
in accordance with the first memory request being a request to access the first specified data in the first data group using the memory mapped mode of access:
executing the persistent memory access command using direct access to the persistent memory that bypasses the file system and block driver.

5. The method of claim 1, further comprising:
receiving a first sequence of memory requests, including the first memory request;
prior to receiving the first sequence of memory requests, receiving a block mode access command;
processing the first sequence of memory requests, including the first memory request, using the block mode of access; and
after processing the first sequence of memory requests:
receiving a memory mapped access command and a second sequence of memory requests; and
processing the second sequence of memory requests using the memory mapped mode of access.

6. The method of claim 5, further comprising, in response to the memory mapped access command, updating the memory map, as needed, such that the first portions of the virtual address space are each mapped to a contiguous set of the second portions in the physical address space.

7. The method of claim 1, further comprising:
executing the persistent memory command to access the one or more locations in persistent memory, wherein executing the persistent memory command comprises accessing a first location and a second location of the one or more locations in persistent memory, the first location corresponding to a location within a first contiguous region of the persistent memory at which the metadata for the first data group is stored, and the second location corresponding to a location within a second contiguous region of the persistent memory at which the data for the first data group is stored.

8. The method of claim 7, wherein the first location and the second location correspond to an index value associated with the first data group.

9. The method of claim 8, further comprising identifying the index value from the address map.

10. The method of claim 7, wherein:
accessing the first location is performed prior to accessing the second location, wherein accessing the first location comprises identifying, from the metadata stored at the first location, the second location at which the data for the first data group is stored; and
accessing the second location comprises accessing the data for the first data group in accordance with the identified second location.

11. The method of claim 10, wherein the first location corresponds to a first index value, and the second location corresponds to a second index value distinct from the first index value.

12. The method of claim 1, wherein the persistent memory is organized into a sequence of extents, each extent having a respective first contiguous region for storing metadata and a respective second contiguous region for storing data.

13. A computing system, comprising:
one or more processors;
memory storing one or more programs configured for execution by the one or more processors, the one or more programs including a user application; and
persistent memory;
wherein the one or more programs, when executed by the one or more processors, cause the computing system to:
detect a first memory request from the user application to access first specified data in a first data group;
store an address map prior to detecting the first memory request, the address map having mapping data specifying a mapping between virtual addresses, used by the user application to access the first data group, and physical addresses in persistent memory at which data and metadata for the first data group is stored, wherein the mapping is consistent with both memory mapped mode access to data in the first data group and block mode access to data in the first data group;
in accordance with the first memory request being a request to access the first specified data in the first data group using a memory mapped mode of access,
translate the first memory request into a persistent memory access command to access one or more locations in persistent memory that are determined in accordance with one or more virtual addresses specified by the first memory request and the stored mapping data; and
in accordance with the first memory request being a request to access the first specified data in the first data group using a block mode of access,
translate the first memory request into a persistent memory access command to access one or more blocks in persistent memory that are determined in accordance with one or more virtual addresses specified by the first memory request and the stored mapping data.

14. The computing system of claim 13, wherein the one or more programs include a persistent memory manager for providing both block mode and memory mapped mode access to the persistent memory.

15. The computing system of claim 13, wherein the virtual addresses are in a virtual address space having first portions of a first size, and the persistent memory having second portions, comprising said physical memory portions of a second size different from the first size; the mapping data specifying a mapping between each first portion to an integer number of second portions, wherein the integer number is greater than one.

16. The computing system of claim 13, wherein the one or more programs include instructions that when executed by the one or more processors cause the computing system to:
in accordance with the first memory request being a request to access the first specified data in the first data group using the memory mapped mode of access:
execute the persistent memory access command using a non-atomic method of execution; and
in accordance with the first memory request being a request to access the first specified data in the first data group using a block mode of access,
execute the persistent memory access command using an atomic method of execution.

17. The computing system of claim 13, wherein the one or more programs include instructions that when executed by the one or more processors cause the computing system to:
receive a first sequence of memory requests, including the first memory request;
prior to receiving the first sequence of memory requests, receive a block mode access command;
process the first sequence of memory requests, including the first memory request, using the block mode of access; and
after processing the first sequence of memory requests:
receive a memory mapped access command and a second sequence of memory requests; and
process the second sequence of memory requests using the memory mapped mode of access.

18. The computing system of claim 13, wherein the one or more programs include instructions that when executed by the one or more processors cause the computing system to update the memory map, as needed, in response to the memory mapped access command, such that the first portions of the virtual address space are each mapped to a contiguous set of the second portions in the physical address space.

19. The computing system of claim 13, wherein the one or more programs include instructions that when executed by the one or more processors cause the computing system to execute the persistent memory command to access the one or more locations in persistent memory, wherein executing the persistent memory command comprises accessing a first location and a second location of the one or more locations in persistent memory, the first location corresponding to a location within a first contiguous region of the persistent memory at which the metadata for the first data group is stored, and the second location corresponding to a location within a second contiguous region of the persistent memory at which the data for the first data group is stored.

20. A non-transitory computer-readable storage medium, storing one or more programs configured for execution by one or more processors of a computing system, the one or more programs including a user application, wherein the one or more programs are configured such that execution of the one or more programs by the one or more processors cause the computing system to:
detect a first memory request from the user application to access first specified data in a first data group;
store an address map prior to detecting the first memory request, the address map having mapping data specifying a mapping between virtual addresses, used by the user application to access the first data group, and physical addresses in persistent memory at which data and metadata for the first data group is stored, wherein the mapping is consistent with both memory mapped mode access to data in the first data group and block mode access to data in the first data group;
in accordance with the first memory request being a request to access the first specified data in the first data group using a memory mapped mode of access,
translate the first memory request into a persistent memory access command to access one or more locations in persistent memory that are determined in accordance with one or more virtual addresses specified by the first memory request and the stored mapping data; and
in accordance with the first memory request being a request to access the first specified data in the first data group using a block mode of access,
translate the first memory request into a persistent memory access command to access one or more blocks in persistent memory that are determined in accordance with one or more virtual addresses specified by the first memory request and the stored mapping data.
